(19) United States
(12) Patent Application Publication
(10) Pub. No.: US 2026/0229946 A1
(43) Pub. Date: Aug. 6, 2026

(54) TORQUE-STABLE TWO-PHASE BRUSHLESS DC MOTOR AND CONTROL METHOD THEREFOR

(71) Applicant: GUANYUE AVIATION TECHNIC (HANGZHOU) CO., LTD., Hangzhou City (CN)

(72) Inventor: YIYANG YU, Hangzhou City (CN)

(73) Assignee: GUANYUE AVIATION TECHNIC (HANGZHOU) CO., LTD., Hangzhou City (CN)

(21) Appl. No.: 19/562,748

(22) Filed: Mar. 10, 2026

Related U.S. Application Data
(63) Continuation of application No. PCT/CN2024/114474, filed on Aug. 26, 2024.

(30) Foreign Application Priority Data
Sep. 13, 2023 (CN) 202311181666.7

(51) Int. Cl. H02K 3/28; H02K 1/14; H02K 1/274; H02K 1/2789; H02K 11/215; H02P 6/04

(52) U.S. Cl. CPC H02K 3/28; H02K 1/146; H02K 1/274; H02K 1/2789; H02K 11/215; H02P 2006/045

(57) ABSTRACT

Disclosed are a torque-stable two-phase brushless DC motor and a control method therefor. The two-phase brushless DC motor includes a stator and a rotor. The stator includes a stator core and 4*n stator windings wound around the stator core, and the rotor includes a rotor core and 6*n permanent magnet poles arranged around the rotor core, wherein n is a positive integer, and polarities of adjacent permanent magnet poles are opposite. The stator windings exhibit high utilization efficiency, thereby reducing the weight of the brushless DC motor and achieving low torque ripple, making it suitable for applications requiring continuous power output.

### CROSS-REFERENCE

This application is a continuation of International Application No. PCT/CN 2024/114474 with a filling date of Aug. 26, 2024, designating the United States, now pending, which further claims to the benefit of priority from Chinese Application No. 202311181666.7 with a filing date of Sep. 13, 2023. The content of the aforementioned applications, including any intervening amendments thereto, are incorporated herein by reference.

### TECHNICAL FIELD

The present application relates to the technical field of brushless DC motors, in particular to a torque-stable two-phase brushless DC motor and a control method therefor.

### BACKGROUND

Brushless DC motors are widely used across various industries, particularly in multi-rotor drones, and they are predominantly employed as the propulsion source. The commonly used brushless DC motors are typically three-phase brushless DC motors.

A conventional three-phase brushless DC motor includes three-phase stator windings and two permanent magnet poles to form a basic unit. That is, the stator windings and the permanent magnet poles are combined in a 3:2 ratio. During operation, an electronic speed controller generates a simulated three-phase AC current, which flows through the stator windings to produce an alternating magnetic field. The magnetic field interacts with the permanent magnet poles via attraction and repulsion forces, thereby converting electrical energy into mechanical rotational energy. However, the following drawbacks exist: the magnetic field has only two poles, and thus, at any time, one of the three stator windings remains inactive, resulting in a winding utilization efficiency of no more than 67%. Since the weight of a brushless DC motor is primarily attributable to the stator core and the stator winding wound on the stator core, the low utilization efficiency of the stator winding significantly reduces the power-to-weight ratio of the motor.

There also exists a technical solution for a two-phase brushless DC motor in which the number of stator windings equals the number of permanent magnet poles. With each step angle advanced, the torque reaches a maximum at the beginning of the step angle and drops to nearly zero at the end of the step angle. This makes it highly unsuitable for applications such as multi-rotor drones which require continuous power output.

### SUMMARY

In order to solve the aforementioned technical problems, the present application provides a torque-stable two-phase brushless DC motor and a control method therefor, which achieves high stator winding utilization efficiency, reduces the weight of the brushless DC motor, and has low torque ripple.

In order to solve the above problems, the present application adopts the following technical solutions.

A torque-stable two-phase brushless DC motor according to the present application comprises a stator and a rotor. The stator comprises a stator core and 4*n stator windings wound around the stator core, and the rotor comprises a rotor core and 6*n permanent magnet poles arranged around the rotor core, wherein n is a positive integer, and polarities of adjacent permanent magnet poles are opposite.

In the present solution, every 4 successively adjacent stator windings constitute a group. The electronic speed controller controls the current phase difference between adjacent stator windings in each group to be 90°, and, in combination with the specific ratio of the number of stator windings to the number of permanent magnetic poles being 4:6, when the torque produced by one stator winding decreases, the torque produced by the adjacent stator winding increases, such that the torques produced by any two adjacent stator windings are in a complementary operating state. It thereby produces stable torque output, solves the problem of high torque ripple inherent in other two-phase brushless DC motors, and is suitable for applications requiring continuous power output.

In the present solution, the ratio of the number of stator windings to the number of permanent magnet poles is 4:6. Compared to a conventional three-phase brushless DC motor, the number of stator windings is reduced. In the present solution, all stator windings are in a normal working state at any time, and the utilization efficiency of the stator windings is improved. The present solution employs only two-thirds the number of stator windings used in a conventional three-phase brushless DC motor. Although the number of permanent magnet poles is correspondingly increased, the overall weight of the brushless DC motor is reduced due to the significantly lower weight of the permanent magnet poles compared to that of the stator windings, thereby improving the power-to-weight ratio.

Preferably, the 4*n stator windings are arranged in a circle and spaced equally on the circle, and the 6*n permanent magnet poles are arranged in a circle and spaced equally on the circle.

Preferably, the rotor core is disposed radially inward of the stator core, the permanent magnet poles are disposed on an outer circumferential surface of the rotor core, and the stator windings are disposed on an inner circumferential surface of the stator core; or the stator core is disposed radially inward of the rotor core, the stator windings are disposed on an outer circumferential surface of the stator core, and the permanent magnet poles are disposed on an inner circumferential surface of the rotor core.

When the rotor is disposed outside the stator, an outer-rotor brushless DC motor is formed; when the rotor is disposed inside the stator, an inner-rotor brushless DC motor is formed.

Preferably, the 4*n stator windings are divided into n groups, each group comprising 4 successively adjacent stator windings which are sequentially designated, in a clockwise direction, as stator winding A, stator winding B, stator winding C, and stator winding D, wherein all stator windings A are connected successively in forward series to form a first series circuit, all stator windings B are connected successively in forward series to form a second series circuit, all stator windings C are connected successively in forward series to form a third series circuit, and all stator windings D are connected successively in forward series to form a fourth series circuit.

Each stator winding has a coil starting end and a coil terminating end. All stator windings A are sequentially numbered as 1, 2, 3 . . . n in the clockwise direction, where 1≤i≤n−1. The coil terminating end of the stator winding A numbered i is connected to the coil starting end of the stator winding A numbered i+1 to form a first series circuit. Similarly, the stator windings B, the stator windings C and the stator windings D are respectively connected to form a second series circuit, a third series circuit and a fourth series circuit.

Since the current phase difference between adjacent stator windings is 90°, the phase difference between stator windings separated by one intervening winding—such as stator winding A and stator winding C, or stator winding B and stator winding D—is either 0° or 180°. The two stator windings separated by one intervening winding can be combined to form a magnetic pole pair, and various approaches may be employed to achieve this.

Preferably, all stator windings are wound in a same direction, the first series circuit and the third series circuit are connected in reverse-parallel to form a first parallel circuit, and the second series circuit and the fourth series circuit are connected in reverse-parallel to form a second parallel circuit.

The coil starting end of the stator winding A numbered 1 in the first series circuit is connected with the coil terminating end of the stator winding C numbered n in the third series circuit, and the coil terminating end of the stator winding A numbered n in the first series circuit is connected to the coil starting end of the stator winding C numbered 1 in the third series circuit to form a first parallel circuit. The coil starting end of the stator winding B numbered 1 in the second series circuit is connected to the coil terminating end of the stator winding D numbered n in the fourth series circuit, and the coil terminating end of the stator winding B numbered n in the second series circuit is connected to the coil starting end of the stator winding D numbered 1 in the fourth series circuit to form a second parallel circuit.

After the first series circuit and the third series circuit are connected in reverse-parallel to form the first parallel circuit, they can share the same control loop of the electronic speed controller. Since the current directions in the stator winding A and the stator winding C are opposite and the winding directions are the same, the current phase difference between the stator winding A and the stator winding C is 180°, and their electromagnetic polarities are opposite at any given time. After the second series circuit and the fourth series circuit are connected in reverse-parallel to form the second parallel circuit, they can share the same control loop of the electronic speed controller. Since the current directions in the stator winding B and the stator winding D are opposite and the winding directions are the same, the current phase difference between the stator winding B and the stator winding D is 180°, and their electromagnetic polarities are opposite at any given time.

Preferably, the torque-stable two-phase brushless DC motor further comprises an electronic speed controller, two terminals of the first parallel circuit are electrically connected to a first input terminal and a first output terminal of the electronic speed controller, respectively, and two terminals of the second parallel circuit are electrically connected to a second input terminal and a second output terminal of the electronic speed controller, respectively.

Preferably, the stator windings A and the stator windings B have the same winding direction, the stator windings C and the stator windings D have the same winding direction, the stator windings A and the stator windings C have opposite winding directions, the stator windings B and the stator windings D have opposite winding directions, the first series circuit and the third series circuit are connected in forward series to form a fifth series circuit, and the second series circuit and the fourth series circuit are connected in forward series to form a sixth series circuit.

After the first series circuit and the third series circuit are connected in forward series to form the fifth series circuit, they can share the same control loop of the electronic speed controller. Since the winding directions of the stator winding A and the stator winding C are opposite and the current directions are the same, the electromagnetic polarities of the stator winding A and the stator winding C are opposite at any given time. After the second series circuit and the fourth series circuit are connected in forward series to form the sixth series circuit, they can share the same control loop of the electronic speed controller. Since the winding directions of the stator winding B and the stator winding D are opposite and the current directions are the same, the electromagnetic polarities of the stator winding B and the stator winding D are opposite at any given time.

Preferably, the torque-stable two-phase brushless DC motor further comprises an electronic speed controller, two terminals of the fifth parallel circuit are electrically connected to a first input terminal and a first output terminal of the electronic speed controller, respectively, and two terminals of the sixth parallel circuit are electrically connected to a second input terminal and a second output terminal of the electronic speed controller, respectively.

Preferably, the stator core is provided with a detection assembly for detecting a position of the rotor, and the detection assembly comprises two or more Hall sensors arranged in the circumferential direction.

A control method for a torque-stable two-phase brushless DC motor according to the present application, for use with the above-mentioned torque-stable two-phase brushless DC motor 4, comprises the step of: controlling, by an electronic speed controller, currents input to the stator windings A, the stator windings B, the stator windings C, and the stator windings D such that a phase difference of 90°is maintained between the currents in adjacent stator windings within each group of stator windings.

The electronic speed controller controls the control current in the stator windings as a sinusoidal wave or a square wave.

The present application has the following beneficial effects: the stator windings exhibit high utilization efficiency, thereby reducing the weight of the brushless DC motor, improving the power-to-weight ratio and achieving low torque ripple, making it suitable for applications requiring continuous power output.

### BRIEF DESCRIPTION OF DRAWINGS

FIG. 1 is a schematic structural view of Embodiment 1.

FIG. 2 illustrates the current waveforms of the stator windings according to Embodiment 1.

FIG. 3 is a schematic structural view of Embodiment 2.

FIG. 4 is an exemplary schematic structural view of Embodiment 2.

### REFERENCE NUMERALS

1 stator core
2 stator winding
3 rotor core
4 permanent magnet pole

### DETAILED DESCRIPTION OF EMBODIMENTS

Hereinafter, the technical solution of the present application will be further described in detail with reference to embodiments and in conjunction with the accompanying drawings.

### Embodiment 1

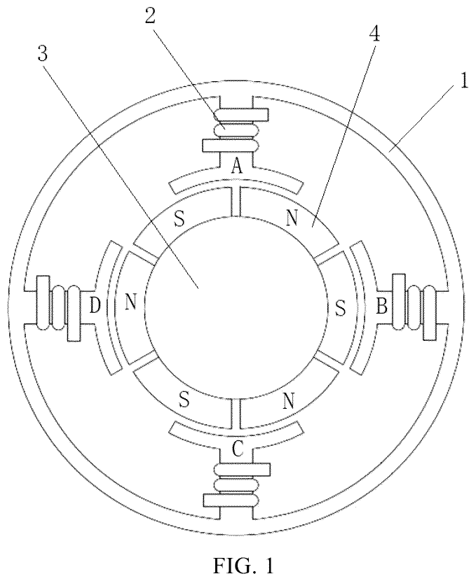

In this embodiment, a torque-stable two-phase brushless DC motor, as shown in FIG. 1, comprises a stator and a rotor. The stator comprises a stator core 1 and 4*n stator windings 2 wound around the stator core 1, the 4*n stator windings 2 being arranged in a circle and spaced equally on the circle. The rotor comprises a rotor core 3 and 6*n permanent magnet poles 4 arranged around the rotor core 3, where n is a positive integer. The 6*n permanent magnet poles 4 are arranged in a circle and spaced equally on the circle and polarities of adjacent permanent magnet poles are opposite.

The rotor core 3 is disposed radially inward of the stator core 1, the permanent magnet poles 4 are disposed on an outer circumferential surface of the rotor core 3, and the stator windings 2 are disposed on an inner circumferential surface of the stator core 1. The stator core 1 is provided with a detection assembly for detecting a position of the rotor, and the detection assembly comprises two or more Hall sensors arranged in the circumferential direction.

In this solution, the rotor is disposed radially inward of the stator, forming an inner-rotor brushless DC motor, and every 4 successively adjacent stator windings constitute a group. The electronic speed controller controls the current phase difference between adjacent stator windings in each group to be 90° (The ideal waveform of the control current is a sinusoidal wave; however, considering cost factors, a square wave (trapezoidal wave) is also acceptable), and, in combination with the specific ratio of the number of stator windings to the number of permanent magnetic poles being 4:6, when the torque produced by one stator winding decreases, the torque produced by the adjacent stator winding increases and vice versa, such that the torques produced by any two adjacent stator windings are in a complementary operating state. It thereby produces stable torque output, solves the problem of high torque ripple inherent in other two-phase brushless DC motors, and is suitable for applications requiring continuous power output.

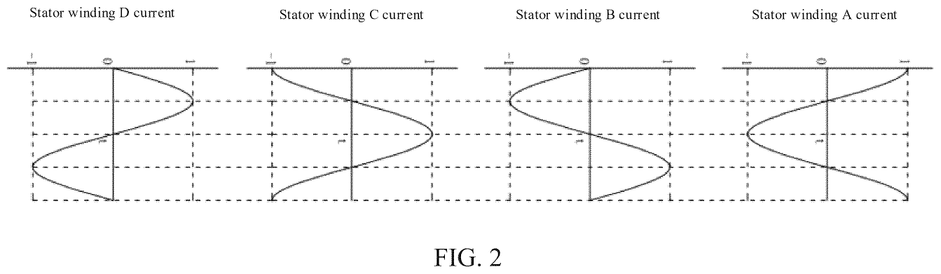

By way of example, a two-phase brushless DC motor comprises 4 stator windings and 6 permanent magnet poles. As shown in FIG. 1, the 4 stator windings are sequentially designated, in the clockwise direction, as stator winding A, stator winding B, stator winding C, and stator winding D. The winding directions of the 4 stator windings are the same. FIG. 1 shows a state of the two-phase brushless DC motor at time t. The currents in the 4 stator windings are shown in FIG. 2. The current phase differences of adjacent stator windings are 90°. The current phase difference between the stator winding A and the stator winding C is 180°, and the current phase difference between the stator winding B and the stator winding D is 180°. At time t, the currents in the stator winding A and the stator winding C reach their maximum values and the stator winding A and the stator winding C are respectively at an intermediate position between two permanent magnet poles, which contribute the most to the torque. The currents in the stator winding B and the stator winding D are exactly 0 and the stator winding B and the stator winding D respectively face a permanent magnet pole, resulting zero contribution to the torque. When the rotor continues to rotate, the contribution of the stator winding A and the stator winding C to the torque gradually decreases, and the contribution of the stator winding B and the stator winding D to the torque gradually increases. When the contribution of the stator winding B and the stator winding D to the torque reaches its maximum, the contribution of the stator winding A and the stator winding C to the torque is just reduced to zero, and the torques produced by the adjacent two stator windings are in a complementary working state, reducing the torque ripple and thereby producing a stable torque output.

In the present solution, the ratio of the number of stator windings to the number of permanent magnet poles is 4:6. Compared to a conventional three-phase brushless DC motor, the number of stator windings is reduced. In the present solution, all stator windings are in a normal working state at any time, and the working efficiency of the stator windings is improved by 50%. The present solution employs only two-thirds the number of stator windings used in a conventional three-phase brushless DC motor. Although the number of permanent magnet poles is correspondingly increased, the overall weight of the brushless DC motor is reduced due to the significantly lower weight of the permanent magnet poles compared to that of the stator windings, thereby improving the power-to-weight ratio.

There are two wiring configurations for the stator windings as described below.

### Configuration 1

The 4*n stator windings 2 are divided into n groups, each group comprising 4 successively adjacent stator windings which are sequentially designated, in the clockwise direction, as stator winding A, stator winding B, stator winding C, and stator winding D, wherein all stator windings A are connected successively in forward series to form a first series circuit, all stator windings B are connected successively in forward series to form a second series circuit, all stator windings C are connected successively in forward series to form a third series circuit, and all stator windings D are connected successively in forward series to form a fourth series circuit. All stator windings are wound in a same direction, the first series circuit and the third series circuit are connected in reverse-parallel to form a first parallel circuit, and the second series circuit and the fourth series circuit are connected in reverse-parallel to form a second parallel circuit.

A torque-stable two-phase brushless DC motor further comprises an electronic speed controller. Two terminals of the first parallel circuit are electrically connected to a first input terminal and a first output terminal of the electronic speed controller, respectively, and two terminals of the second parallel circuit are electrically connected to a second input terminal and a second output terminal of the electronic speed controller, respectively.

Each stator winding has a coil starting end and a coil terminating end. All stator windings A are sequentially numbered as 1, 2, 3 . . . n in the clockwise direction, where 1≤i≤n−1. The coil terminating end of the stator winding A numbered i is connected to the coil starting end of the stator winding A numbered i+1 to form a first series circuit. Similarly, the stator windings B, the stator windings C and the stator windings D are respectively connected to form a second series circuit, a third series circuit and a fourth series circuit.

The coil starting end of the stator winding A numbered 1 in the first series circuit is connected with the coil terminating end of the stator winding C numbered n in the third series circuit, and the coil terminating end of the stator winding A numbered n in the first series circuit is connected to the coil starting end of the stator winding C numbered 1 in the third series circuit to form a first parallel circuit. The coil starting end of the stator winding B numbered 1 in the second series circuit is connected to the coil terminating end of the stator winding D numbered n in the fourth series circuit, and the coil terminating end of the stator winding B numbered n in the second series circuit is connected to the coil starting end of the stator winding D numbered 1 in the fourth series circuit to form a second parallel circuit.

After the first series circuit and the third series circuit are connected in reverse-parallel to form the first parallel circuit, they can share the same control loop of the electronic speed controller. Since the current directions in the stator winding A and the stator winding C are opposite and the winding directions are the same, the current phase difference between the stator winding A and the stator winding C is 180°, and their electromagnetic polarities are opposite at any given time. After the second series circuit and the fourth series circuit are connected in reverse-parallel to form the second parallel circuit, they can share the same control loop of the electronic speed controller. Since the current directions in the stator winding B and the stator winding D are opposite and the winding directions are the same, the current phase difference between the stator winding B and the stator winding D is 180°, and their electromagnetic polarities are opposite at any given time.

### Configuration 2

The 4*n stator windings 2 are divided into n groups, each group comprising 4 successively adjacent stator windings which are sequentially designated, in the clockwise direction, as stator winding A, stator winding B, stator winding C, and stator winding D, wherein all stator windings A are connected successively in forward series to form a first series circuit, all stator windings B are connected successively in forward series to form a second series circuit, all stator windings C are connected successively in forward series to form a third series circuit, and all stator windings D are connected successively in forward series to form a fourth series circuit. the stator windings A and the stator windings B have the same winding direction, the stator windings C and the stator windings D have the same winding direction, the stator windings A and the stator windings C have opposite winding directions, the stator windings B and the stator windings D have opposite winding directions, the first series circuit and the third series circuit are connected in forward series to form a fifth series circuit, and the second series circuit and the fourth series circuit are connected in forward series to form a sixth series circuit.

A torque-stable two-phase brushless DC motor further comprises an electronic speed controller, two terminals of the fifth parallel circuit are electrically connected to a first input terminal and a first output terminal of the electronic speed controller, respectively, and two terminals of the sixth parallel circuit are electrically connected to a second input terminal and a second output terminal of the electronic speed controller, respectively.

Each stator winding has a coil starting end and a coil terminating end. All stator windings A are sequentially numbered as 1, 2, 3 . . . n in the clockwise direction, where 1≤i≤n−1. The coil terminating end of the stator winding A numbered i is connected to the coil starting end of the stator winding A numbered i+1 to form a first series circuit. Similarly, the stator windings B, the stator windings C and the stator windings D are respectively connected to form a second series circuit, a third series circuit and a fourth series circuit.

The coil terminating end of the stator winding A numbered n in the first series circuit is connected to the coil starting end of the stator winding C numbered 1 in the third series circuit to form a fifth series circuit. The coil terminating end of the stator winding B numbered n in the second series circuit is connected to the coil starting end of the stator winding D numbered 1 in the fourth series circuit to form a sixth series circuit.

After the first series circuit and the third series circuit are connected in forward series to form the fifth series circuit, they can share the same control loop of the electronic speed controller. Since the winding directions of the stator winding A and the stator winding C are opposite and the current directions are the same, the electromagnetic polarities of the stator winding A and the stator winding C are opposite at any given time. After the second series circuit and the fourth series circuit are connected in forward series to form the sixth series circuit, they can share the same control loop of the electronic speed controller. Since the winding directions of the stator winding B and the stator winding D are opposite and the current directions are the same, the electromagnetic polarities of the stator winding B and the stator winding D are opposite at any given time.

A two-phase brushless DC motor comprising 4 stator windings and 6 permanent magnet poles is only a most basic combination. In actual use, the configuration can be scaled proportionally according to requirements to derive combinations with a ratio of the number of stator windings to the number of permanent magnet poles of 4:6, such as 8:12, 12:18, 16:24, and so on, to adapt to different application scenarios.

A control method for a torque-stable two-phase brushless DC motor according to the present embodiment, for use with the above-mentioned torque-stable two-phase brushless DC motor 4, comprises the step of:

The electronic speed controller controls the control current in the stator windings as a sinusoidal wave or a square wave.

When the two-phase brushless DC motor adopts the stator winding connection configuration of Configuration 1, the control method is as follows: The electronic speed controller controls the current phase difference between the first parallel circuit and the second parallel circuit to be 90°. That is, the current phase difference between the stator winding A and the stator winding B is 90°, the current phase difference between the stator winding B and the stator winding C is 90°, the current phase difference between the stator winding C and the stator winding D is 90°, the current phase difference between the stator winding A and the stator winding C is 180°, and the current phase difference between the stator winding B and the stator winding D is 180°.

When the two-phase brushless DC motor adopts the stator winding connection configuration of Configuration 2, the control method is as follows: The electronic speed controller controls the current phase difference between the fifth series circuit and the sixth series circuit to be 90°. That is, the current phase difference between the stator winding A and the stator winding B is 90°, the current phase difference between the stator winding B and the stator winding C is 90°, the current phase difference between the stator winding C and the stator winding D is 90°, the current phase difference between the stator winding A and the stator winding C is 0°, and the current phase difference between the stator winding B and the stator winding D is 0°.

By way of example, a two-phase brushless DC motor comprises 4 stator windings and 6 permanent magnet poles. As shown in FIG. 1, the 4 stator windings are sequentially designated, in the clockwise direction, as stator winding A, stator winding B, stator winding C, and stator winding D. the winding directions of the 4 stator windings are the same. The 6 permanent magnet poles are sequentially designated, in the clockwise direction, as a first permanent magnet pole of N polarity, a second permanent magnet pole of S polarity, a third permanent magnet pole of N polarity, a fourth permanent magnet pole of S polarity, a fifth permanent magnet pole of N polarity, and a sixth permanent magnet pole of S polarity. Initially, stator winding B directly faces the second permanent magnet pole of S polarity, and stator winding D directly faces the fifth permanent magnet pole of N polarity; half of stator winding A is aligned with half of the first permanent magnet pole and the other half of stator winding A is aligned with half of the sixth permanent magnet pole; half of stator winding C is aligned with half of the third permanent magnet pole and the other half of stator winding C is aligned with half of the fourth permanent magnet pole; and the electronic speed controller controls the current phase difference between adjacent stator windings in each group to be 90°. Initially, the currents in the stator winding A and the stator winding C reach their maximum values and are in opposite directions, and the currents in the stator winding B and the stator winding D are 0.

### Embodiment 2

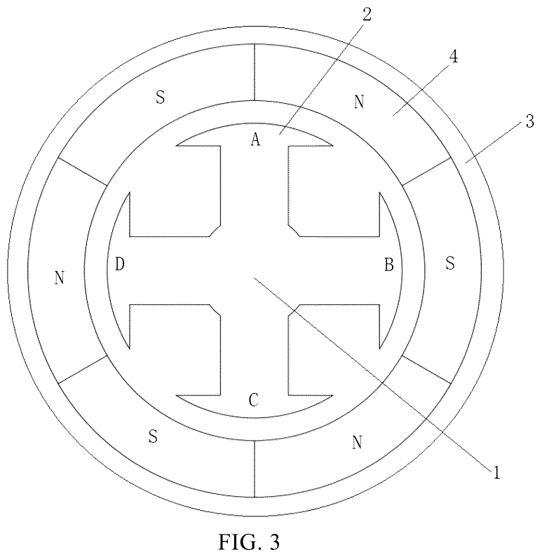

The structure of this embodiment is substantially the same as that of Embodiment 1, except that, as shown in FIG. 3, the stator core 1 is disposed radially inward of the rotor core 3, the stator windings 2 are disposed on an outer circumferential surface of the stator core 1, and the permanent magnet poles 4 are disposed on an inner circumferential surface of the rotor core 3.

In the present solution, the rotor is disposed radially outward of the stator, forming an outer-rotor brushless DC motor.

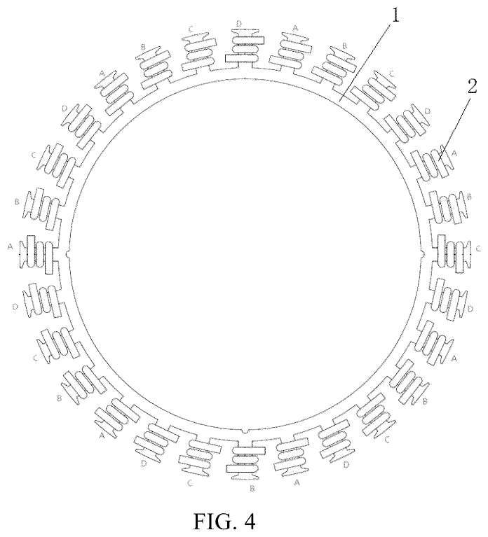

By way of example, a two-phase brushless DC motor comprises 28 stator windings and 42 permanent magnet poles. The stator is shown in FIG. 4, wherein the 28 stator windings are divided into 7 groups. Each group of stator windings comprises 4 successively adjacent stator windings. The 4 successively adjacent stator windings are sequentially designated, in the clockwise direction, as stator winding A, stator winding B, stator winding C, and stator winding D. The rotor comprising 42 permanent magnet poles can be directly implemented using the rotor of an existing three-phase brushless DC motor, thereby reducing development costs.

A control method for a torque-stable two-phase brushless DC motor according to the present embodiment, for use with the above-mentioned torque-stable two-phase brushless DC motor 4, is identical to that of Embodiment 1.

What is claimed is:

1. A torque-stable two-phase brushless DC motor, comprising a stator and a rotor;
wherein the stator comprises a stator core and 4*n stator windings wound around the stator core, and the rotor comprises a rotor core and 6*n permanent magnet poles arranged around the rotor core, where n is a positive integer, and polarities of adjacent permanent magnet poles are opposite.

2. The torque-stable two-phase brushless DC motor according to claim 1, wherein the 4*n stator windings are arranged in a circle and spaced equally on the circle, and the 6*n permanent magnet poles are arranged in a circle and spaced equally on the circle.

3. The torque-stable two-phase brushless DC motor according to claim 1, wherein the rotor core is disposed radially inward of the stator core, the permanent magnet poles are disposed on an outer circumferential surface of the rotor core, and the stator windings are disposed on an inner circumferential surface of the stator core; or
the stator core is disposed radially inward of the rotor core, the stator windings are disposed on an outer circumferential surface of the stator core, and the permanent magnet poles are disposed on an inner circumferential surface of the rotor core.

4. The torque-stable two-phase brushless DC motor according to claim 1, wherein the 4*n stator windings are divided into n groups, each group comprising 4 successively adjacent stator windings which are sequentially designated, in a clockwise direction, as stator winding A, stator winding B, stator winding C, and stator winding D;
wherein all stator windings A are connected successively in forward series to form a first series circuit, all stator windings B are connected successively in forward series to form a second series circuit, all stator windings C are connected successively in forward series to form a third series circuit, and all stator windings D are connected successively in forward series to form a fourth series circuit.

5. The torque-stable two-phase brushless DC motor according to claim 4, wherein all stator windings are wound in a same direction, the first series circuit and the third series circuit are connected in reverse-parallel to form a first parallel circuit, and the second series circuit and the fourth series circuit are connected in reverse-parallel to form a second parallel circuit.

6. The torque-stable two-phase brushless DC motor according to claim 5, further comprising an electronic speed controller, two terminals of the first parallel circuit are electrically connected to a first input terminal and a first output terminal of the electronic speed controller, respectively, and two terminals of the second parallel circuit are electrically connected to a second input terminal and a second output terminal of the electronic speed controller, respectively.

7. The torque-stable two-phase brushless DC motor according to claim 4, wherein the stator windings A and the stator windings B have the same winding direction, the stator windings C and the stator windings D have the same winding direction, the stator windings A and the stator windings C have opposite winding directions, the stator windings B and the stator windings D have opposite winding directions;
the first series circuit and the third series circuit are connected in forward series to form a fifth series circuit, and the second series circuit and the fourth series circuit are connected in forward series to form a sixth series circuit.

8. The torque-stable two-phase brushless DC motor according to claim 7, further comprising an electronic speed controller, two terminals of the fifth parallel circuit are electrically connected to a first input terminal and a first output terminal of the electronic speed controller, respectively, and two terminals of the sixth parallel circuit are electrically connected to a second input terminal and a second output terminal of the electronic speed controller, respectively.

9. The torque-stable two-phase brushless DC motor according to claim 1, wherein the stator core (1) is provided with a detection assembly for detecting a position of the rotor, and the detection assembly comprises two or more Hall sensors arranged in the circumferential direction.

10. A control method for a torque-stable two-phase brushless DC motor, for use with the torque-stable two-phase brushless DC motor according to claim 4, characterized by comprising the step of: controlling, by an electronic speed controller, currents input to the stator windings A, the stator windings B, the stator windings C, and the stator windings D such that a phase difference of 90° is maintained between the currents in adjacent stator windings within each group of stator windings.
